(19) United States
(12) Patent Application Publication
(10) Pub. No.: US 2026/0118589 A1
(43) Pub. Date: Apr. 30, 2026

(54) INTEGRATED GRATING COUPLER AND OPTICAL SYSTEM USING THE SAME

(71) Applicant: VisEra Technologies Company Limited, Hsin-Chu City (TW)

(72) Inventors: Kuo-Fang CHUNG, Hsin-Chu City (TW); Hsin-Yi HSIEH, Hsin-Chu City (TW); Po-Han FU, Hsin-Chu City (TW); Shih-Liang KU, Hsin-Chu City (TW)

(21) Appl. No.: 18/928,616

(22) Filed: Oct. 28, 2024

(51) Int. Cl. G02B 6/34

(52) U.S. Cl. CPC G02B 6/34

(57) ABSTRACT

An integrated grating coupler is provided. The integrated grating coupler includes a substrate and a reflector disposed on the substrate. The integrated grating coupler also includes a metal grating structure disposed over the reflector. The integrated grating coupler further includes a waveguide disposed over the metal grating structure, wherein the waveguide includes a main grating structure.

### BACKGROUND OF THE INVENTION

### Field of the Invention

The present disclosure relates to an integrated grating coupler, and, in particular, to an integrated grating coupler that includes a metal grating structure and an optical system using the integrated grating coupler.

### Description of the Related Art

Integrated sensing devices have recently become popular for biological analysis. For example, a traditional integrated grating coupler may be used to measure, identify, or sequence an analyte (e.g., glucose, virus/bacteria, or DNA fragment) in a medium (e.g., interstitial fluid (ISF), blood, saliva, or nasal mucous membrane) collected from a living organism (e.g. a human) for health condition monitoring, disease diagnostic, or DNA sequencing. Grating couplers are often integrated into integrated sensing devices. However, traditional grating couplers require the optical source to have a diameter of beam size that is quite small (e.g., about 2-10 μm) and allow a very small alignment offset (e.g., about 1 μm) to achieve good optical coupling. Therefore, a novel integrated grating coupler is still needed.

### BRIEF SUMMARY OF THE INVENTION

In the embodiments of the present disclosure, the integrated grating coupler includes a reflector and a metal grating structure disposed over the reflector, which may effectively improve the optical coupling efficiency for the optical source with a large diameter of beam size (e.g., about 50 μm). Therefore, the integrated grating coupler, when embedded in a disposable biochip, exhibits a greater alignment tolerance (e.g., >10 μm). This feature facilitates quick plug-and-play alignment with the operational machine (which provides the light source, reagent handling, and signal acquisition), making it more versatile for use in various biological sensing devices and optical systems.

An embodiment of the present invention provides an integrated grating coupler. The integrated grating coupler includes a substrate and a reflector disposed on the substrate. The integrated grating coupler also includes a metal grating structure disposed over the reflector. The integrated grating coupler further includes a waveguide disposed over the metal grating structure, wherein the waveguide includes a main grating structure.

In some embodiments, the reflector includes high-refractive films and low-refractive films that are stacked in alternating order.

In some embodiments, the width of the metal grating structure is greater than 1 μm, and less than or equal to 100 μm, and the maximum thickness of the metal grating structure is greater than or equal to 0.1 μm, and less than or equal to 2 μm.

In some embodiments, the metal grating structure has multiple recessed portions that have the same depth, and the depth of the recessed portions is greater than 0, and less than or equal to the maximum thickness of the metal grating structure.

In some embodiments, the shortest distance between the metal grating structure and the waveguide is equal to the shortest distance between the metal grating structure and the reflector.

In some embodiments, the shortest distance between the metal grating structure and the reflector is greater than 0, and less than or equal to 3 μm.

In some embodiments, the shortest distance between the reflector and the waveguide is greater than or equal to 0.1 μm, and less than or equal to 6 μm.

In some embodiments, the width of the main grating structure is greater than or equal to 10 μm, and less than or equal to 300 μm. More specifically, the width of the main grating structure is greater than or equal to 10 μm, and less than or equal to 100 μm.

In some embodiments, the width of the metal grating structure that overlaps the main grating structure on the waveguide is less than half of the width of the main grating structure.

In some embodiments, the maximum thickness of the main grating structure is greater than or equal to 0.16 μm, and less than or equal to 0.6 μm.

In some embodiments, the main grating structure has multiple recessed portions that have the same depth, and the depth of the recessed portions is greater than or equal to 0.04 μm, and less than or equal to the maximum thickness of the main grating structure.

In some embodiments, the main grating structure has multiple recessed portions that have different depths.

In some embodiments, the main grating structure has different pitches.

In some embodiments, the main grating structure is formed of an irregular pattern, and the irregular pattern includes no-etched patterns, shallow-etched patterns, and fully-etched patterns.

In some embodiments, the grated grating coupler further includes a first cladding layer disposed between the reflector and the waveguide, wherein the metal grating structure is disposed in the first cladding layer.

In some embodiments, the grated grating coupler further includes a second cladding layer disposed on the waveguide.

In some embodiments, the thickness of the second cladding layer above the waveguide is greater than 0, and less than or equal to 2 μm.

An embodiment of the present invention provides an optical system. The optical system includes an integrated grating coupler and an optical source disposed above the integrated grating coupler. The integrated grating coupler includes a substrate and a reflector disposed on the substrate. The integrated grating coupler also includes a metal grating structure disposed over the reflector. The integrated grating coupler further includes a waveguide disposed over the metal grating structure, wherein the waveguide includes a main grating structure.

In some embodiments, the extension of the optical axis of the optical source is separated from the metal grating structure.

In some embodiments, the diameter of beam size of the optical source is greater than or equal to 2 μm, and less than or equal to 2000 μm. More specifically, the diameter of beam size of the optical source is greater than or equal to 10 μm, and less than or equal to 200 μm.

### BRIEF DESCRIPTION OF THE DRAWINGS

The disclosure can be more fully understood from the following detailed description when read with the accompanying figures. It is worth noting that, in accordance with standard practice in the industry, various features are not drawn to scale. In fact, the dimensions of the various features may be arbitrarily increased or reduced for clarity of discussion.

FIG. 1 is a partial cross-sectional view illustrating the integrated grating coupler and the optical system according to some embodiments of the present disclosure.

FIG. 2 is a partial cross-sectional view illustrating the integrated grating coupler according to some other embodiments of the present disclosure.

FIG. 3 is a partial top view illustrating the main grating structure according to some other embodiments of the present disclosure.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in following embodiments. This repetition is for the purpose of simplicity and clarity and does not in itself dictate a relationship between the various embodiments and/or configurations discussed.

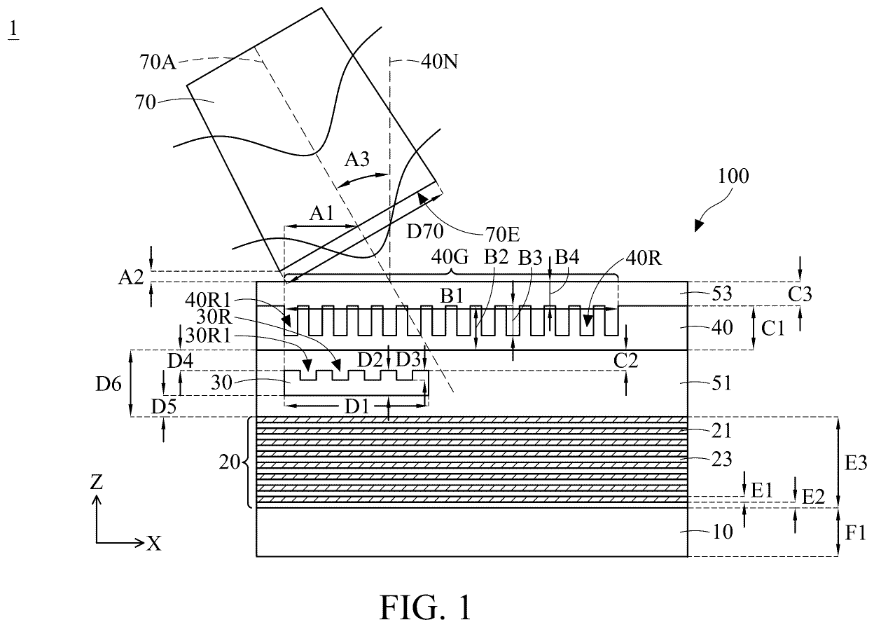

FIG. 1 is a partial cross-sectional view illustrating the integrated grating coupler 10 and the optical system 1 according to some embodiments of the present disclosure. It should be noted that some components of the integrated grating coupler 10 and the optical system 1 have been omitted in FIG. 1 for the sake of brevity.

Referring to FIG. 1, in some embodiments, the optical system 1 includes an integrated grating coupler 100 and an optical source 70 disposed above the integrated grating coupler 100. The integrated grating coupler 100 may be used for on-chip-device or on-wafer-device testing. In more detail, the integrated grating coupler 100 may be used for coupling light from the optical source 70. For example, the optical source 70 may be a visible-light laser-beam pointer, but the present disclosure is not limited thereto.

In some embodiments, the operating band of the optical source 70 (i.e., light from the optical source 70) may be in the range from about 400 nm to about 750 nm, from about 300 nm to about 1800 nm, or from about 250 nm to about 3500 nm, but the present disclosure is not limited thereto. As shown in FIG. 1, in some embodiments, the diameter of beam size D70 of the optical source 70 is greater than or equal to about 2 μm, and less than or equal to about 2000 μm. More specifically, the diameter of beam size D70 of the optical source 70 is greater than or equal to about 10 μm, and less than or equal to about 200 μm. That is, the optical source 70 may have large mode field diameter (MFD), which may be about 50 μm, or about 10 μm to about 200 μm, about 5 μm to about 500 μm, or about 2 μm to about 2000 μm.

Referring to FIG. 1, in some embodiments, the integrated grating coupler 100 includes a substrate 10, which may have a photoelectric conversion element that is not shown in FIG. 1. For example, the substrate 10 may be a glass substrate or a semiconductor substrate (e.g., CMOS substrate), and the photoelectric conversion element may be a photodiode. The substrate 10 may include a flexible material, such as polyethylene terephthalate (PET), polysulfone (PES), polyimide (PI), polycarbonate (PC), polymethylmethacrylate (PMMA), silicone, epoxy, the like, or a combination thereof. The substrate 10 may also include a rigid material, such as a glass, a quartz, or a sapphire. However, the present disclosure is not limited thereto. In some embodiments, the thickness F1 of the substrate 10 is greater than or equal to about 200 μm, and less than or equal to 850 μm. Here, the thickness F1 of the substrate 10 may be defined as the distance between the topmost and the bottommost of the substrate 10 in Z-direction (i.e., vertical distance) in FIG. 1.

Referring to FIG. 1, in some embodiments, the integrated grating coupler 100 includes a reflector 20 disposed on the substrate 10. For example, the reflector 20 may be a distributed Bragg reflector (DBR) mirror, but the present disclosure is not limited thereto. As shown in FIG. 1, in some embodiments, the reflector includes high-refractive films 21 and low-refractive films 23 that are stacked in alternating order. For example, the high-refractive film 21 may be titanium dioxide (TiO₂), tantalum pentoxide (Ta₂O₅), silicon nitride (Si₃N₄), silicon (Si), niobium pentoxide (Nb₂O₅), and the low-refractive film 23 may be silicon dioxide (SiO₂). The high-refractive films 21 and the low-refractive films 23 may be formed by a deposition process. The deposition process is, for example, chemical vapor deposition (CVD), plasma enhanced chemical vapor deposition (PECVD), atomic layer deposition (ALD), any other similar process, or a combination thereof, but the present disclosure is not limited thereto.

In some embodiments, the thickness E1 of a single high-refractive film 21 is λ/4/n_{H}, the thickness E2 of a single low-refractive film 23 is λ/4/n_{L}, and the thickness E3 of the reflector 20 (i.e., the total thickness of the high-refractive films 21 and the low-refractive films 23) is greater than or equal to about 0.5 μm, and less than or equal to 50 μm. More specifically, the thickness E3 of the reflector 20 is greater than or equal to about 1 μm, and less than or equal to 5 μm. Here, the thickness E3 of the reflector 20 may be defined as the distance between the topmost and the bottommost of the reflector 20 in Z-direction (i.e., vertical distance) in FIG. 1. Moreover, λ is the wavelength of light emitted from the optical source 70, n_{H} is the refractive index of the high-refractive film 21, and n_{L} is the refractive index of the low-refractive film 23.

Referring to FIG. 1, in some embodiments, the integrated grating coupler 100 includes a metal grating structure 30 disposed over the reflector 20. For example, the metal grating structure 30 may include aluminum (Al), gold (Au), silver (Ag), any other suitable material, or a combination thereof, but the present disclosure is not limited thereto. The metal grating structure 30 may be formed by a deposition process, a photolithography process, and an etching process, but the present disclosure is not limited thereto. For example, the photolithography process may include photoresist coating (e.g., spin coating), soft baking, mask aligning, exposure, post-exposure baking (PEB), developing, rinsing, drying (for example, hard baking), any other suitable process, or a combination thereof, but the present disclosure is not limited thereto.

In some embodiments, the width D1 of the metal grating structure 30 (that overlaps the main grating structure 40G on the waveguide 40) is greater than 1 μm, and less than or equal to about 100 μm. Here, the width D1 of the metal grating structure 30 may be defined as the distance between the leftmost and the rightmost of the metal grating structure 30 in X-direction (i.e., horizontal distance) in FIG. 1.

In some embodiments, the maximum thickness D2 of the metal grating structure 30 is greater than or equal to about 0.1 μm, and less than or equal to about 2 μm. Here, the maximum thickness D2 of the metal grating structure 30 may be defined as the distance between the topmost and the bottommost of the metal grating structure 30 in Z-direction (i.e., vertical distance) in FIG. 1. Moreover, as shown in FIG. 1, in some embodiments, the metal grating structure 30 has multiple recessed portions 30R that have the same depth D3, and the depth D3 of the recessed portions 30R is greater than 0, and less than or equal to the maximum thickness D2 of the metal grating structure 30.

Referring to FIG. 1, in some embodiments, the integrated grating coupler 100 includes a waveguide 40 disposed over the metal grating structure 30, and the waveguide 40 includes a main grating structure 40G. For example, the waveguide 40 may include silicon (Si), silicon nitride (SiN), tantalum oxide (Ta₂O₅), titanium oxide (TiO), aluminum oxide (AlO), any other similar material, or a combination thereof, but the present disclosure is not limited thereto. The waveguide 40 may be formed by a deposition process, a photolithography process, and an etching process, but the present disclosure is not limited thereto.

In some embodiments, the width B1 of the main grating structure 40G is greater than and equal to about 10 μm, and less than or equal to about 300 μm. More specifically, the width of the main grating structure is greater than or equal to about 10 μm, and less than or equal to about 100 μm. Here, the width B1 of the main grating structure 40G may be defined as the distance between the leftmost and the rightmost of the main grating structure 40G in X-direction (i.e., horizontal distance) in FIG. 1. The width D1 of the metal grating structure 30 may be changed depending on the width B1 of the main grating structure 40G. In some embodiments, the width D1 of the metal grating structure 30 that overlaps the main grating structure 40G on the waveguide 40 is less than half of the width of the main grating structure 40G.

In some embodiments, the maximum thickness B2 of the main grating structure 40G is greater than or equal to about 0.16 μm, and less than or equal to about 0.6 μm. Here, the maximum thickness B2 of the main grating structure 40G may be defined as the distance between the topmost and the bottommost of the main grating structure 40G in Z-direction (i.e., vertical distance) in FIG. 1. In other words, the thickness C1 of a portion of the waveguide 40 other than the main grating structure 40G may be substantially equal to the maximum thickness B2 of the main grating structure 40G. Moreover, as shown in FIG. 1, in some embodiments, the main grating structure 40G has multiple recessed portions 40R that have the same depth B3 in Z-direction (i.e., vertical distance) in FIG. 1, and the depth B3 of the recessed portions 40R is greater than 0, and less than or equal to the maximum thickness B2 of the main grating structure 40G.

In some embodiments, the shortest distance D4 between the metal grating structure 30 and the main grating structure 40G (or the waveguide 40) is equal to the shortest distance D5 between the metal grating structure 30 and the reflector 20 in Z-direction (i.e., vertical distance) in FIG. 1. In some embodiments, the shortest distance D5 between the metal grating structure 30 and the reflector 20 is greater than 0, and less than or equal to about 3 μm in Z-direction (i.e., vertical distance) in FIG. 1. In other words, the shortest distance C2 between the metal grating structure 30 and the portion of the waveguide 40 other than the main grating structure 40G may be substantially equal to the shortest distance D4 between the metal grating structure 30 and the main grating structure 40G) Z-direction (i.e., vertical distance) in FIG. 1. Moreover, as shown in FIG. 1, in some embodiments, the shortest distance D6 between the reflector 20 and the waveguide 40 is greater than or equal to about 0.1 μm, and less than or equal to about 6 μm in Z-direction (i.e., vertical distance) in FIG. 1.

As shown in FIG. 1, in some embodiments, the integrated grating coupler 100 includes a first cladding layer 51 disposed between the reflector 20 and the waveguide 40, and the metal grating structure 30 is disposed in the first cladding layer 51. Moreover, the integrated grating coupler 100 further includes a second cladding layer 53 disposed on the waveguide 40. In more detail, some portions of the second cladding layer 53 are disposed in the recessed portions 40R of the main grating structure 40G.

In some embodiments, the thickness B4 of the second cladding layer 53 above the main grating structure 40G in Z-direction (i.e., vertical distance) in FIG. 1 is greater than 0, and less than or equal to about 2 μm. In other words, the thickness C3 of the second cladding layer 53 above the waveguide 40 in Z-direction (i.e., vertical distance) in FIG. 1 is greater than 0, and less than or equal to about 2 μm.

As shown in FIG. 1, in some embodiments, the shortest distance A1 between the center of the light-emitting surface 70E of the optical source 70 and the leftmost of the main grating structure 40G in X-direction (i.e., horizontal distance) in FIG. 1 is greater than or equal to 0, and less than or equal to half of the diameter of beam size D70 of the optical source 70 Moreover, the shortest distance A2 between the optical source 70 and the integrated grating coupler 100 (second cladding layer 53) in Z-direction (i.e., vertical distance) in FIG. 1 is greater than 0, and less than or equal to about 10 μm.

In some embodiments, the extension of the optical axis 70A of the optical source 70 is separated from the metal grating structure 30. Moreover, in some embodiments, the included angle A3 between the optical axis 70A of the optical source 70 and the normal direction 40N of the main grating structure 40G is substantially between about −10° and about +10°, and the included angle A3 between the optical axis 70A of the optical source 70 and the normal direction 40N of the main grating structure 40G may be extended to between about 30° and about +30°.

In the embodiments of the present disclosure, the metal grating structure 30 may effectively improve the optical coupling efficiency of the main grating structure 40G. Furthermore, to reduce substrate transmittance loss and improve the optical coupling efficiency of the main grating structure 40G, the reflector 20 (e.g., an additional distributed Bragg reflector (DBR)) is integrated beneath the main grating structure 40G to achieve maximum constructive interference. To accomplish this, the reflector 20, which includes multiple periodic thin film combinations (e.g., high-refractive films 21 and low-refractive films 23), leverages the mechanism of constructive interference during reflection to achieve phase alignment for constructive interference.

Taking the integrated grating coupler 100 and the optical system 1 shown in FIG. 1 as an example, simulate the experiment with the parameters set as follows: the wavelength of light emitted from the optical source 70 is set to be about 532 nm; the diameter of beam size D70 of the optical source 70 is set to be about 50 μm; the shortest distance A1 between the center of the light-emitting surface 70E of the optical source 70 and the leftmost of the main grating structure 40G is set to be about 14 μm; the shortest distance A2 between the optical source 70 and the integrated grating coupler 100 (second cladding layer 53) is set to be about 10 μm; the included angle A3 between the optical axis 70A of the optical source 70 and the normal direction 40N of the main grating structure 40G is set to be about 27.3°; the number of periods of the main grating structure 40G is set to be 155; the pitch (period) of the main grating structure 40G is about 353 nm; the depth B3 of the recessed portions 40R in the main grating structure 40G is set to be about 48 nm; the thickness of the second cladding layer 52 is set to be about 2.619 μm; the number of periods of the metal grating structure 30 is set to be 21; the pitch (period) of the metal grating structure 30 is set to be about 761 nm; the maximum thickness D2 of the metal grating structure 30 is set to be about 792 nm; the horizontal distance between the first recessed portion 40R1 in the main grating structure 40G and the first recessed portions 30R1 in the metal grating structure 30 is set to be about 8.551 μm; and the number of high-refractive films 21 and the number of low-refractive films 23 are set to be 20.

In this example, the optimized coupling efficiency (CE) of the integrated grating coupler 100 may be about 56.4%. In a comparative example that is without the metal grating structure 30, the optimized coupling efficiency (CE) of the integrated grating coupler may be about 38.0%. In another comparative example that is without the reflector 20, the optimized coupling efficiency (CE) of the integrated grating coupler may be about 3.23%. In still another comparative example that is without the reflector 20 and the metal grating structure 30, the optimized coupling efficiency (CE) of the integrated grating coupler may be about 3.20%.

That is, the integrated grating coupler 100 according to the embodiments, of the present disclosure, which includes a reflector 20 and a metal grating structure 30 disposed over the reflector 20, may effectively improve the optical coupling efficiency. Therefore, the optical source 70 may have a large diameter of beam size D70. Therefore, the integrated grating coupler 100, when embedded in a disposable biochip, exhibits a greater alignment tolerance (e.g., >10 μm). This feature facilitates quick plug-and-play alignment with the operational machine (which provides the light source, reagent handling, and signal acquisition), making it more versatile for use in various biological sensing devices and optical systems.

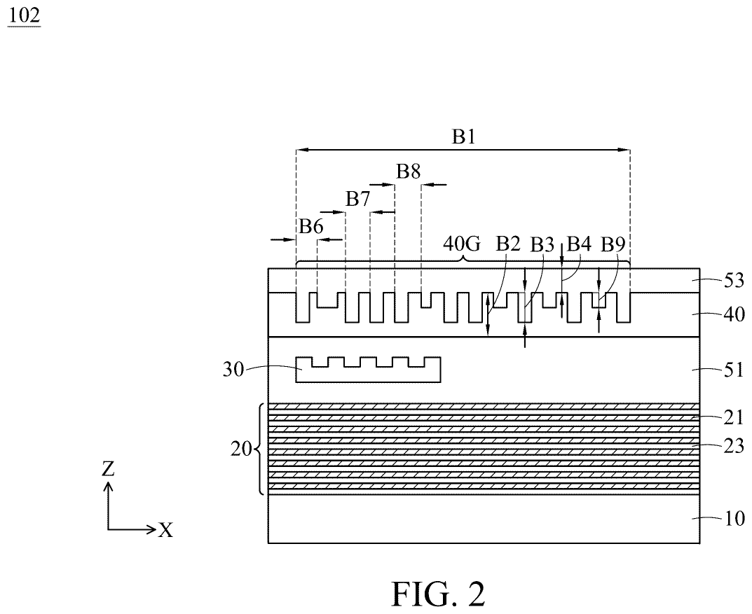

FIG. 2 is a partial cross-sectional view illustrating the integrated grating coupler 102 according to some other embodiments of the present disclosure. Similarly, some components of the integrated grating coupler 102 have been omitted in FIG. 2 for the sake of brevity.

Referring to FIG. 2, in this embodiment, the main grating structure 40G has different pitches. Here, the pitch of the main grating structure 40G may be defined as the distance between the leftmost of the recessed portion 40R and the leftmost of the adjacent recessed portion 40R in X-direction (i.e., horizontal distance) in FIG. 2. As shown in FIG. 2, the pitch B6 the main grating structure 40G is not equal to the pitch B7 or the pitch B8 of the main grating structure 40G.

Moreover, as shown in FIG. 2, in this embodiment, the main grating structure 40 has multiple recessed portions 30R that have different depths in Z-direction (i.e., vertical distance) in FIG. 2. For example, the depth B3 of the recessed portions 40R is different from the depth B9 of the recessed portions 40R.

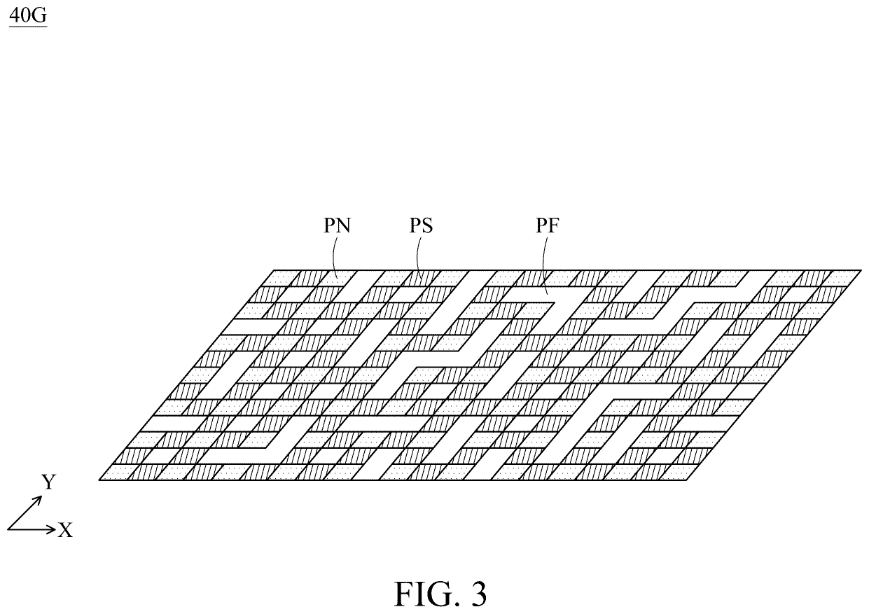

FIG. 3 is a partial top view illustrating the main grating structure 40G according to some other embodiments of the present disclosure. It should be noted that the top view shown in FIG. 3 is not a direct top-down view of the main grating structure 40G.

Referring to FIG. 3, in this embodiment, the main grating structure 40G is formed of an irregular pattern, and the irregular pattern include no-etched patterns (PN), shallow-etched patterns (PS), and fully-etched patterns (PF). Different etching depth can be utilized along with tailored sub-wavelength grating period (along with direction) to form synthesized blazed or apodized grating within X-Z (propagation-height) cross-section view and thus higher coupling efficiency can be achieved. Here, no-etched patterns (PN) indicate a grating structure on the original waveguide 40 that protrudes from the original upper surface of the waveguide 40 without removing the material of the waveguide 40 by the etching process; shallow-etched patterns (PS) indicate a grating structure on the original waveguide 40 that protrudes from the original upper surface of the waveguide 40, and then a shallow etching process is performed to remove part of the material of the waveguide 40 (not etched completely); And fully-etched patterns (PF)indicate a grating structure on the original waveguide 40 that protrudes from the original upper surface of the waveguide 40, and then a shallow etching process is performed to fully remove the material of the waveguide 40 (etched completely).

As noted above, the integrated grating coupler according to the embodiments of the present disclosure includes a reflector and a metal grating structure disposed over the reflector, which may effectively improve the optical coupling efficiency. Therefore, the optical source may have a large diameter of beam size. Therefore, the integrated grating coupler, when embedded in a disposable biochip, exhibits a greater alignment tolerance (e.g., >10 μm). This feature facilitates quick plug-and-play alignment with the operational machine (which provides the light source, reagent handling, and signal acquisition), making it more versatile for use in various biological sensing devices and optical systems.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

What is claimed is:

1. An integrated grating coupler, comprising:
a substrate;
a reflector disposed on the substrate;
a metal grating structure disposed over the reflector; and
a waveguide disposed over the metal grating structure, wherein the waveguide comprises a main grating structure.

2. The integrated grating coupler as claimed in claim 1, wherein the reflector comprises high-refractive films and low-refractive films that are stacked in alternating order.

3. The integrated grating coupler as claimed in claim 1, wherein a width of the metal grating structure is greater than 1 μm, and less than or equal to 100 μm, and a maximum thickness of the metal grating structure is greater than or equal to 0.1 μm, and less than or equal to 2 μm.

4. The integrated grating coupler as claimed in claim 3, wherein the metal grating structure has multiple recessed portions that have the same depth, and the depth of the recessed portions is greater than 0, and less than or equal to the maximum thickness of the metal grating structure.

5. The integrated grating coupler as claimed in claim 1, wherein a shortest distance between the metal grating structure and the waveguide is equal to a shortest distance between the metal grating structure and the reflector.

6. The integrated grating coupler as claimed in claim 5, wherein the shortest distance between the metal grating structure and the reflector is greater than 0, and less than or equal to 3 μm.

7. The integrated grating coupler as claimed in claim 1, wherein a shortest distance between the reflector and the waveguide is greater than or equal to 0.1 μm, and less than or equal to 6 μm.

8. The integrated grating coupler as claimed in claim 1, wherein a width of the main grating structure is greater than or equal to 10 μm, and less than or equal to 300 μm.

9. The integrated grating coupler as claimed in claim 8, wherein a width of the metal grating structure is less than half of the width of the main grating structure.

10. The integrated grating coupler as claimed in claim 1, wherein a maximum thickness of the main grating structure is greater than or equal to 0.16 μm, and less than or equal to 0.6 μm.

11. The integrated grating coupler as claimed in claim 10, wherein the main grating structure has multiple recessed portions that have the same depth, and the depth of the recessed portions is greater than or equal to 0.04 μm, and less than or equal to the maximum thickness of the main grating structure.

12. The integrated grating coupler as claimed in claim 1, wherein the main grating structure has multiple recessed portions that have different depths.

13. The integrated grating coupler as claimed in claim 1, wherein the main grating structure has different pitches.

14. The integrated grating coupler as claimed in claim 1, wherein the main grating structure is formed of an irregular pattern, and the irregular pattern comprises no-etched patterns, shallow-etched patterns, and fully-etched patterns.

15. The integrated grating coupler as claimed in claim 1, further comprising:
a first cladding layer disposed between the reflector and the waveguide, wherein the metal grating structure is disposed in the first cladding layer.

16. The integrated grating coupler as claimed in claim 15, further comprising:
a second cladding layer disposed on the waveguide.

17. The integrated grating coupler as claimed in claim 16, wherein a thickness of the second cladding layer above the waveguide is greater than 0, and less than or equal to 2 μm.

18. An optical system, comprising:
an integrated grating coupler, comprising:
a substrate;
a reflector disposed on the substrate;
a metal grating structure disposed over the reflector; and
a waveguide disposed over the metal grating structure, wherein the waveguide comprises a main grating structure; and
an optical source disposed above the integrated grating coupler.

19. The optical system as claimed in claim 18, wherein an extension of an optical axis of the optical source is separated from the metal grating structure.

20. The optical system as claimed in claim 18, wherein a diameter of beam size of the optical source is greater than or equal to 2 μm, and less than or equal to 2000 μm.
